(19) United States
(12) Patent Application Publication
(10) Pub. No.: US 2013/0205594 A1
(43) Pub. Date: Aug. 15, 2013

(54) Vacuum Shaver

(71) Applicant: Yuriy Zakuskin, Orekhov (UA)

(72) Inventor: Yuriy Zakuskin, Orekhov (UA)

(73) Assignee: Oak Novations, Ltd.

(21) Appl. No.: 13/370,299

(22) Filed: Feb. 9, 2012

(51) Int. Cl. B26B 19/42; B26B 19/00

(52) U.S. Cl. 30/34.2

(57) ABSTRACT

A vacuum shaver includes a nozzle having one or more cutting surfaces and an electric motor. The vacuum shaver can also include an air moving member coupled to the electric motor and a battery. The electric motor can provide mechanical power to the air moving member which can guide air through an air movement guide configured to guide airflow in through the nozzle, past the air moving member and out an exhaust vent.

Embodiments relate generally to electric shavers, and, more particularly, to electric shavers having a vacuum source to draw air toward a cutting surface of the shaver.

An embodiment includes a vacuum shaver with a nozzle having one or more cutting surfaces and an electric motor. The vacuum shaver can also include an air moving member coupled to the electric motor and a battery. The electric motor can provide mechanical power to the air moving member which can guide air through an air movement guide configured to guide airflow in through the nozzle, past the air moving member and out an exhaust vent.

The vacuum shaver can be housed in a case (e.g., a plastic or metal case) enclosing the electric motor, the air moving member, the battery and the air movement guide. The vacuum shaver can also include rechargeable battery (e.g., lithium ion or the like) and a charging circuit coupled to the battery.

The one or more cutting surfaces can include a plurality of razor blades. The nozzle can be removable and disposable. The air movement member can be an impeller, a fan or a flexible membrane.

Another embodiment can include a vacuum shaver having a case, a nozzle having one or more cutting surfaces, the nozzle being removably coupled to an end of the case. The shaver can also include an electric actuator, an air moving member coupled to the electric actuator, and a battery. The shaver can further include an air movement guide configured to guide airflow in through the nozzle, past the air moving member and out an exhaust vent. The shaver can also include a charging circuit coupled to the battery, wherein the battery is a rechargeable battery and the charging circuit is adapted to recharge the battery.

The one or more cutting surfaces can include a plurality of razor blades. The nozzle can be disposable. The air movement member can be a flexible membrane. The electric actuator can be an electromagnetic actuator.

Yet another embodiment includes a vacuum shaver system having a central vacuum source and a plurality of vacuum shavers each having a nozzle with one or more cutting surfaces. The vacuum shaver system can also include a plurality of vacuum hoses each with a first end coupled to a respective one of the vacuum shavers and a second end coupled to the central vacuum source.

The one or more cutting surfaces can include a plurality of razor blades. The nozzle can be disposable.

### BRIEF DESCRIPTION OF THE DRAWINGS

FIGS. 1A and 1B show diagrams of vacuum shavers in accordance with at least one embodiment.

FIG. 2 is a cut away view of an exemplary vacuum shaver in accordance with at least one embodiment.

FIG. 3 is a diagram of an exemplary cutting end/nozzle of a vacuum shaver in accordance with at least one embodiment.

FIG. 4 is a diagram of an exemplary vacuum shaver showing details of the air movement member and electric motor in accordance with at least one embodiment.

FIG. 5 is a diagram of an exemplary vacuum shaver showing details of the air movement member and electric motor in accordance with at least one embodiment.

FIG. 6 is a diagram of an exemplary vacuum shaver showing details of the air movement member and electric actuator in accordance with at least one embodiment.

FIG. 7 is a diagram of an exemplary vacuum shaver system in accordance with at least one embodiment.

### DETAILED DESCRIPTION

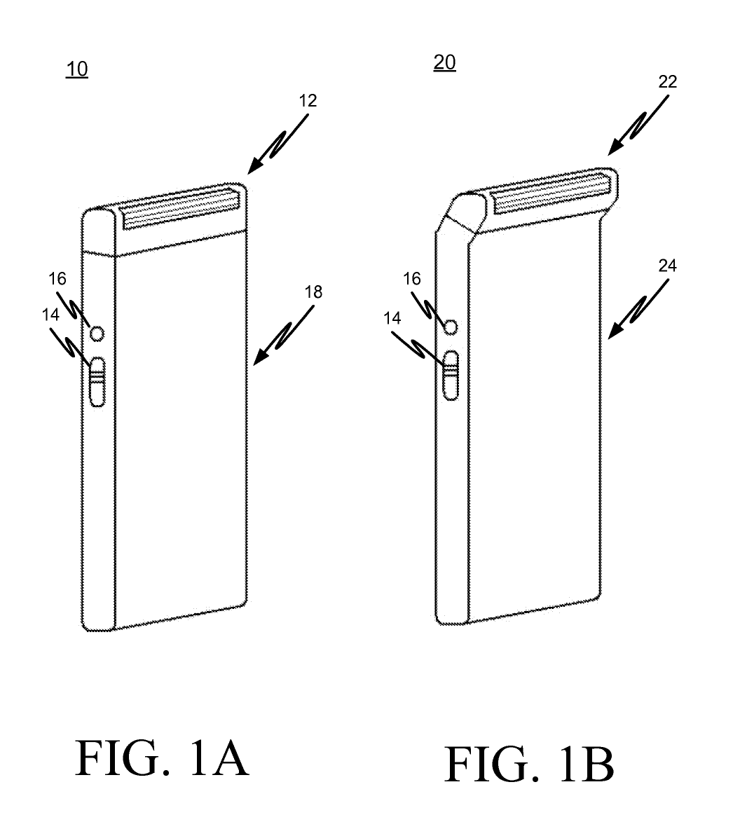

FIGS. 1A and 1B show diagrams of exemplary vacuum shavers. FIG. 1A shows a vacuum shaver 10 with a straight nozzle/cutting surface 12, a power switch 14, and indicator 16 and a case 18.

FIG. 1B shows a vacuum shaver 20 having a power switch 14, an indicator 16, an angled nozzle/cutting surface 22 and a case 24.

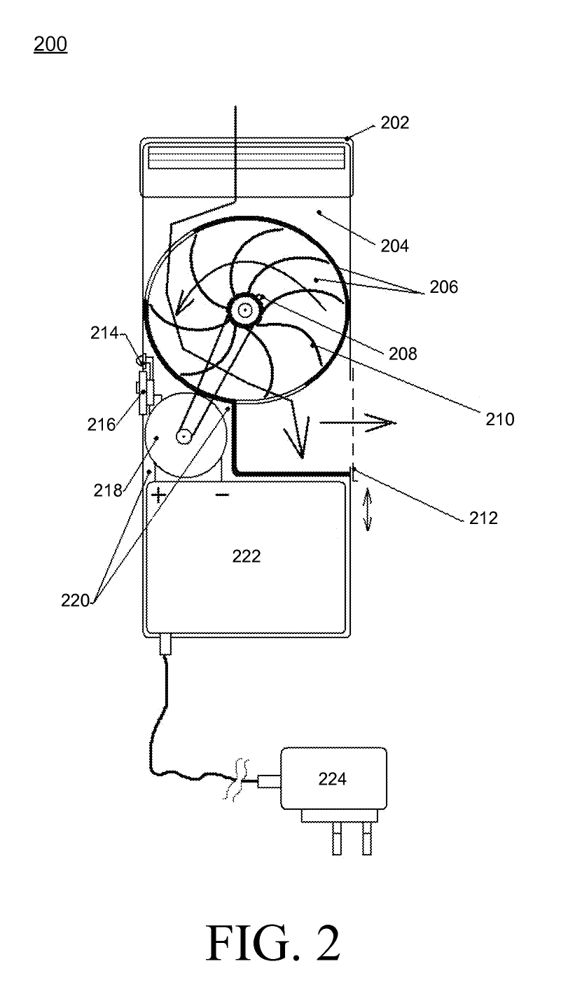

FIG. 2 is a cut away view of an exemplary vacuum shaver 200. The vacuum shaver 200 includes a disposable nozzle/cutting surface 202 with disposable cap, housing cavity 204, impeller-type air pump 206, small weight for creating vibrations 208 (optional), rubber fan 210, exhaust opening (or vent) 212, indicator 214, power switch 216, electric motor 218, sealed area 220 surrounding electric motor, battery 222 and charger 224.

In operation, air is drawn in through the nozzle/cutting edge 202 by a vacuum created in the housing cavity 204. The air pump 206 creates the vacuum in the housing cavity 204. Small vibrations can be created when the optional weight 208 is installed. A fan 210 is disposed in the air pump 206 to move air through the air pump 206. The fan 210 can be made of rubber.

As air is moved from the nozzle 202 and past the air pump 206, the air can be exhausted through the exhaust opening 212.

The air pump 206 is powered by the electric motor 218, which receives electrical power from the battery 222. The battery 222 can be a lithium ion battery, for example.

The vacuum created in the shaver can be helpful in at least two ways: first, skin can be drawn to the nozzle/cutting surface, and second, the hair can be raised for better cutting. Also, the optional weight can add vibration to the shaver which may also improve shaving.

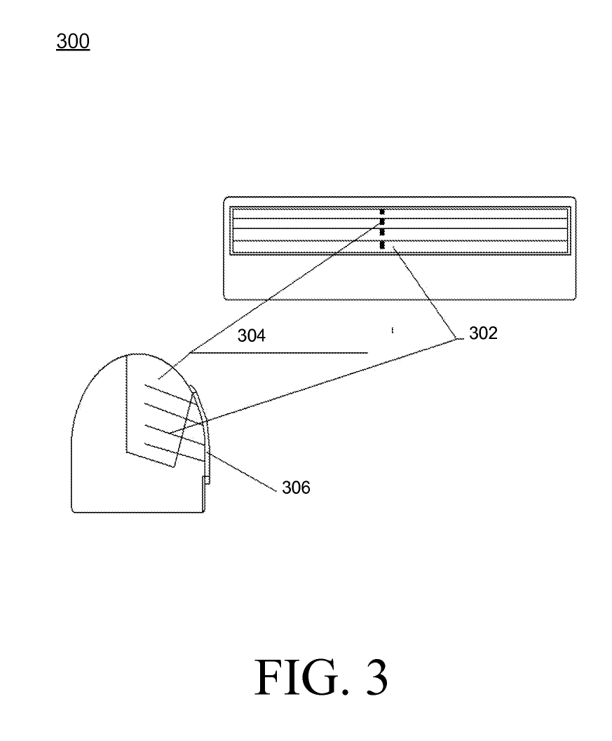

FIG. 3 is a diagram of an exemplary cutting end/nozzle 300. The nozzle 300 includes a plurality of blades 302. The nozzle 300 can also include one or more additional blades 304 for strength. The nozzle 300 can also include a rubber ferrule 306.

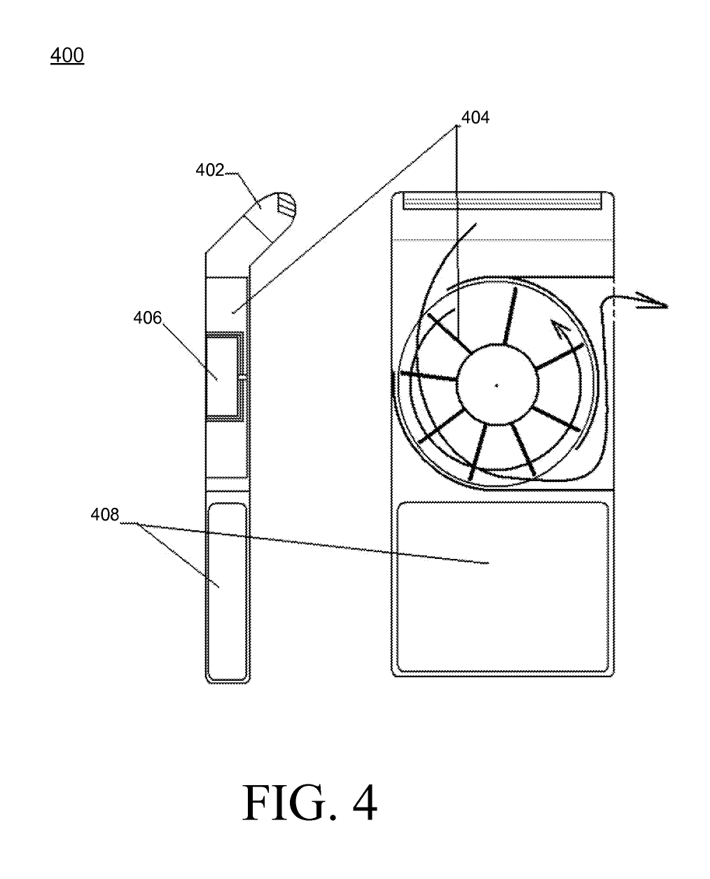

FIG. 4 is a diagram of an exemplary vacuum shaver 400 having an angled nozzle/cutting edge 402, an impeller-type air pump 404, an electric motor 406, and a battery 408.

In operation, the battery 408 provides power to the electric motor 406, which turns the impeller-type pump 404 and causes a vacuum to be created within the shaver case.

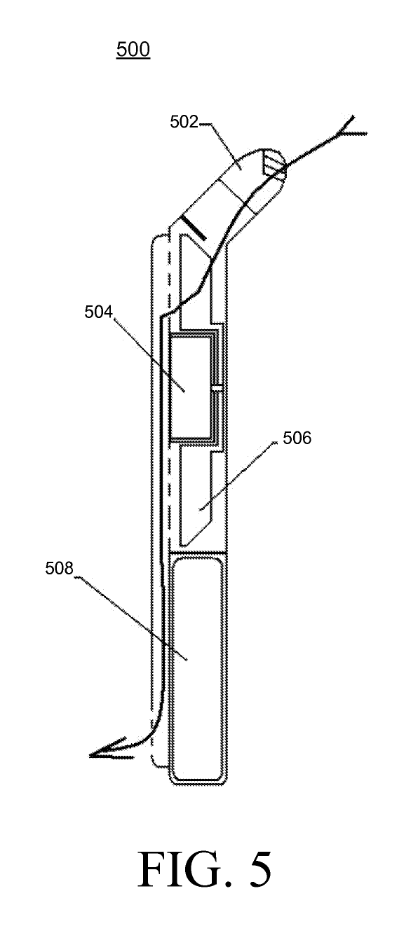

FIG. 5 shows a side view of an exemplary vacuum shaver 500 having a nozzle/cutting head 502, an electric motor 504, fan blades 506 and a battery 508. The electric motor 504 is coupled to the battery 508 for electric power and to the fan blades 506.

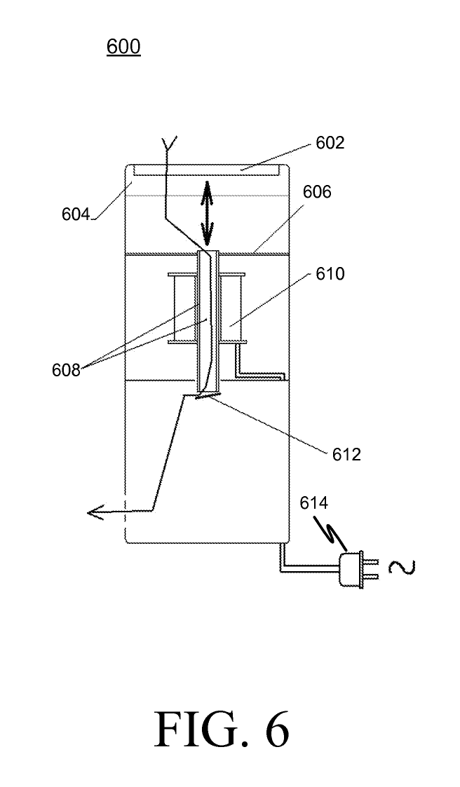

FIG. 6 is a diagram of an exemplary vacuum shaver 600 having a replaceable nozzle 604 with blades 602. The shaver 600 also includes a rubber membrane 606, an electric actuator 610 (e.g., an electromagnetic coil), metal tube/anchor 608, an electromagnetic coil 610, an exhaust valve 612 and an electric source 614.

In operation, the tube/anchor 608 is set in motion by the electric actuator 610, which in turn moves the rubber membrane 606 up and down. The air flow and/or debris will be collected released through the exhaust valve 612.

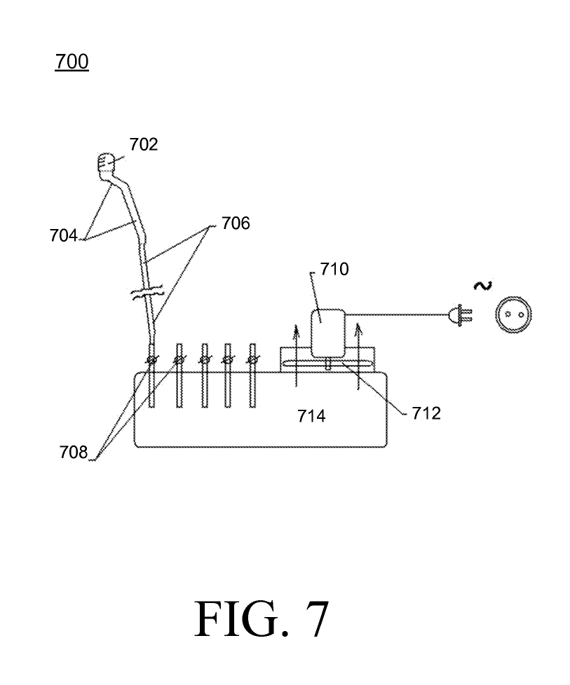

FIG. 7 is a diagram of an exemplary vacuum shaver system 700 that includes replaceable nozzle with cutting edges 702, shaver handle 704 and a hose for supplying vacuum 706. The system also includes a plurality of connection points 708 for handheld razors.

The vacuum shaver system also includes an electric motor 710 and air fan 712. The motor 710 and fan 712 are coupled to the vacuum case 714. It will be appreciated that although one disposable nozzle and hose combination is shown, more could be used.

It will be appreciated that other standard components can be used, but have been omitted from the drawings for purposes of clearly conveying the various embodiments. Standard components can include, but are not limited to, control circuits, recharging circuits and the like.

It is, therefore, apparent that there is provided, in accordance with the various embodiments disclosed herein, a vacuum shaver and a vacuum shaver system.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A vacuum shaver comprising:
a nozzle having one or more cutting surfaces;
an electric motor;
an air moving member coupled to the electric motor;
a battery coupled to the electric motor; and
an air movement guide configured to guide airflow in through the nozzle, past the air moving member and out an exhaust vent.

2. The vacuum shaver of claim 1, further comprising a case enclosing the electric motor, the air moving member, the battery and the air movement guide.

3. The vacuum shaver of claim 1, further comprising a charging circuit coupled to the battery, wherein the battery is a rechargeable battery and the charging circuit is adapted to recharge the battery.

4. The vacuum shaver of claim 1, wherein the one or more cutting surfaces includes a plurality of razor blades.

5. The vacuum shaver of claim 1, wherein the nozzle is removable.

6. The vacuum shaver of claim 5, wherein the nozzle is disposable.

7. The vacuum shaver of claim 1, wherein the air movement member is an impeller.

8. The vacuum shaver of claim 1, wherein the air movement member is a fan.

9. The vacuum shaver of claim 1, wherein the air movement member is flexible membrane.

10. A vacuum shaver comprising:
a case;
a nozzle having one or more cutting surfaces, the nozzle being removably coupled to an end of the case;
an electric actuator;
an air moving member coupled to the electric actuator;
a battery coupled to the electric actuator; and
an air movement guide configured to guide airflow in through the nozzle, past the air moving member and out an exhaust vent.

11. The vacuum shaver of claim 10, further comprising a charging circuit coupled to the battery, wherein the battery is a rechargeable battery and the charging circuit is adapted to recharge the battery.

12. The vacuum shaver of claim 10, wherein the one or more cutting surfaces includes a plurality of razor blades.

13. The vacuum shaver of claim 10, wherein the nozzle is disposable.

14. The vacuum shaver of claim 10, wherein the air moving member is flexible membrane.

15. The vacuum shaver of claim 10, wherein the electric actuator is an electromagnetic actuator.

16. A vacuum shaver system comprising:
a central vacuum source;
a plurality of vacuum shavers each having a nozzle with one or more cutting surfaces; and
a plurality of vacuum hoses with a first end coupled to a respective one of the vacuum shavers and a second end coupled to the central vacuum source.

17. The vacuum shaver system of claim 16, wherein the one or more cutting surfaces includes a plurality of razor blades.

18. The vacuum shaver system of claim 16, wherein the nozzle is disposable.
